(19) United States
(12) Patent Application Publication
(10) Pub. No.: US 2003/0038398 A1
(43) Pub. Date: Feb. 27, 2003

(54) Method and device for producing carbon long-fiber-reinforced concrete members

(76) Inventor: Toshiaki Ohta, Fukuoka-ken (JP)

Correspondence Address: Russell D Orkin, 700 Koppers Building, 436 Seventh Avenue, Pittsburgh, PA, 15219-1818, US

(21) Appl. No.: 10/221,546

(22) PCT Filed: Jan. 22, 2001
(86) PCT No.: PCT/JP01/00374

(51) Int. Cl. B29C 39/18

(52) U.S. Cl. 264/228; 264/277; 425/111; 249/91

(57) ABSTRACT

Long carbon fibers f₀ are stretched between a couple of anchor-installing bases 40L, 40R. Continuous carbon fibers f are drawn out of a reel 34 on a carrier 30 and helically wound around the stretched long carbon fibers f₀, by combination of rotation of the stands 40L, 40R with unidirectional travel of the base 30. A reinforcing element composed of the long carbon fibers f₀ and the continuous carbon fibers f is set in a molding box 60, and fresh concrete is cast from a tank 62 in the molding box 60. Since the stretched reinforcing element is embedded in cured concrete, a fabricated concrete member is very strong with high reliability on quality and performance.

### INDUSTRIAL FIELD OF THE INVENTION

The present invention relates to a method of manufacturing a carbon fiber-reinforced concrete member useful as a pillar, column, spar, beam or the like of building, civil engineering or offshore structure and so on, and also relates to an apparatus therefor.

### BACKGROUND OF THE INVENTION

A pillar, column, spar, beam or the like in a building, constructing or engineering field is made from a concrete member reinforced with a steel rod or fiber reinforced plastic (FRP). Although the steel rod or FRP is an effective reinforcement, a broad workspace is necessary for processing and handling the reinforced concrete member, and automation of processing and handling is also difficult. As a result, high-price working is unavoidable. Especially in the case where steel rods as reinforcement are too big in diameter to facilitate automation of bending or other processing, shaping and gas pressure-welding of the steel rods are performed by skilled workers, resulting in increase of a working cost. Length of a main steel rod for reinforcement of a bridge pier is also limited to 10 m or so at longest under traffic regulations. Due to restriction on length, gas pressure welding is essential on work site. Furthermore, decrease in population of workers skilled at shaping and gas pressure-welding of steel rods in these days causes fears about defective construction originated in manpower and time shortages, which often occurs in a season when constructing works are jammed. Such the fears lose reliability on safety of construction.

Due to these situations, construction using concrete members is affected by weather and technical potential of workers, and varied in joint performance with a high working cost. Even if reinforced concrete members are assembled at a factory, a huge space is necessary for storage of products, and neither storing nor shipment works are easy because of heavy weight. Conditions of storage shall be severely controlled so as to protect products, which have been assembled and stored at the factory, from corrosion, too. Transportation of products is also difficult and expensive because of size and weight. In this sense, factory-fabrication of reinforced concrete members does not well meet with variety of needs on a work site. Difficulty on scrap processing and recycling is also disadvantage against the recent tendency to keep a healthy environment.

Several improvements have been proposed in order to eliminate the above-mentioned defects. For instance, JP 5-248091 A1 or JP 10-76341 A1 discloses an apparatus for automatically reforming and feeding steel rods. JP 11-156842 A1 discloses a concrete member reinforced with flexible long fibers. However, difficulty on fabrication and handling of a reinforced concrete member is still unsettled.

Use of flexible fibers as reinforcement really saves a working space necessary for fabrication and preparation of a reinforcing element. But, arrangement of long fibers in stretched state is difficult and so dependent on experience of workers. Arrangement of long fibers is typically difficult, when main long fibers located along an axial direction of a concrete member are hooped with additional long fibers.

### SUMMARY OF THE INVENTION

The present invention aims at reinforcement of a concrete member with hooped carbon fibers held at a proper position, by stretching long carbon fibers between a couple of anchor-installing bases and hooping the long carbon fibers with continuous carbon fibers during rotation of the anchor-installing bases.

The present invention proposes a method of manufacturing a carbon fiber-reinforced concrete member, wherein a plurality of anchors are detachably attached to a couple of anchor-installing bases, a plurality of long carbon fibers are stretched and fixed to the anchors at the both ends, continuous carbon fibers are wound around the stretched long carbon fibers with a right or inclined angle, the assembled reinforcing element is put in a molding box, and concrete is cast in the molding box under the condition that a tension is applied through the anchor to the reinforcing element.

Continuous carbon fibers are preferably bonded to long carbon fibers, which have both ends secured to anchors, at their crossing points with adhesive. Spacers may be located at a space inside the long carbon fibers, which are stretched between the anchor-installing bases, in proper intervals along an axial direction. The spacers inhibits dislocation of the continuous carbon fibers as well as the long carbon fibers and assures maintenance of a vacancy with a proper shape defined by the reinforcing element.

The reinforcing element fabricated in this way is either put in a molding box for casting concrete at a factory, or folded to a compact size suitable for transportation. In the latter case, the reinforcing element is re-stretched on the work site and put in a molding box for casting concrete.

An apparatus for manufacturing a carbon fiber-reinforced concrete member has a couple of anchor-installing bases. A plurality of anchors are detachably attached to the bases, for fixing both ends of long carbon fibers along an axial direction of a concrete member. A carrier, which travels between the anchor-installing bases, has a reel for drawing out continuous carbon fibers toward the anchors and a vessel for supply of adhesive mounted thereon.

The continuous carbon fibers are wound around the long carbon fibers stretched between the anchor-installing bases with a right or inclined angle, by rotation of the anchor-installing bases and simultaneous unidirectional travel of the carrier. A molding box, which receives the reinforcing element therein before casting concrete, is located movably along a vertical direction between the anchor-installing bases. The proposed apparatus enables manufacturing a reinforced concrete member with size well-fitting to a practical demand on a work site.

### BRIEF DESCRIPTION OF THE DRAWINGS

FIG. 1 is a view for explaining a process for manufacturing a carbon fiber-reinforced concrete member step by step according to the present invention.

FIG. 2 is a sectional side view illustrating continuous carbon fibers wound around long carbon fibers, which are stretched along an axial direction of a concrete member, with a right or inclined angle.

FIG. 3A is a view illustrating an anchor-installing base.

FIG. 3B is a view illustrating a L-shaped anchor which is attached to the anchor-installing base.

FIG. 3C is a view illustrating a spacer located at a space inside stretched long carbon fibers.

FIG. 4 is a view illustrating a tool for applying a tension to long carbon fibers.

### PREFERRED EMBODIMENT OF THE INVENTION

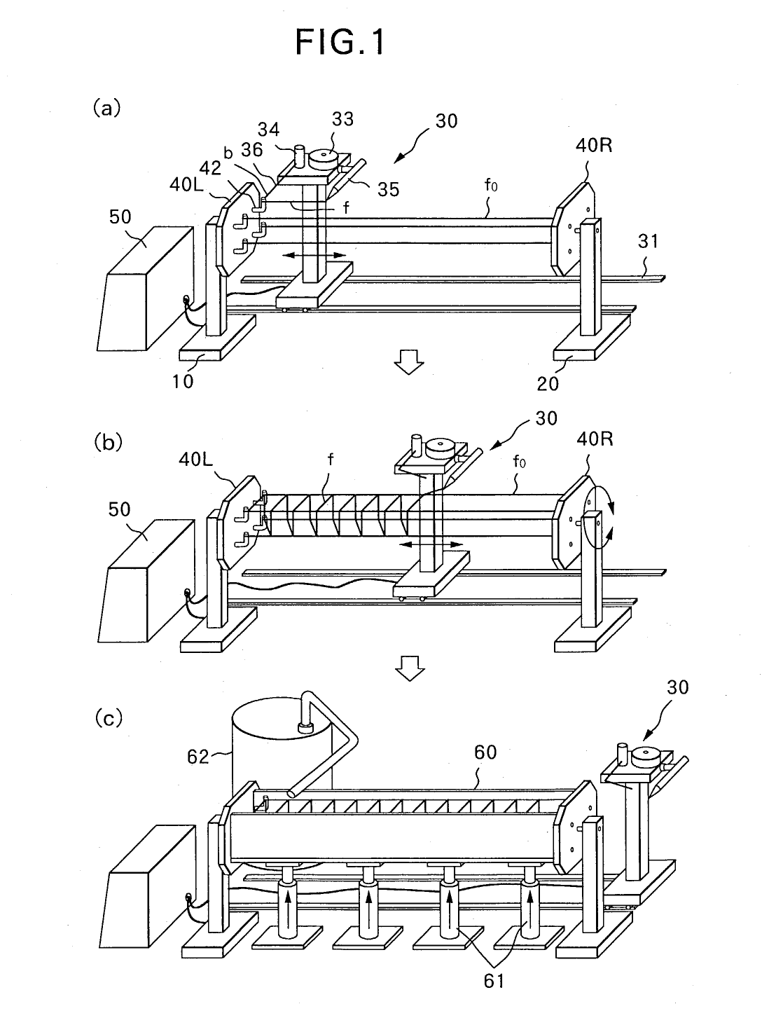

Other features of the present invention will be apparent from the following explanation for manufacturing a carbon fiber-reinforced concrete member, consulting with FIGS. 1 to 4, although the explanation does not put any restrictions on a scope of the present invention.

A couple of stands 10, 20 are located in a distance corresponding to a length of an objective reinforced concrete member, as shown in FIG. 1. A carrier 30 travels on rails 31 provided between the stands 10, 20.

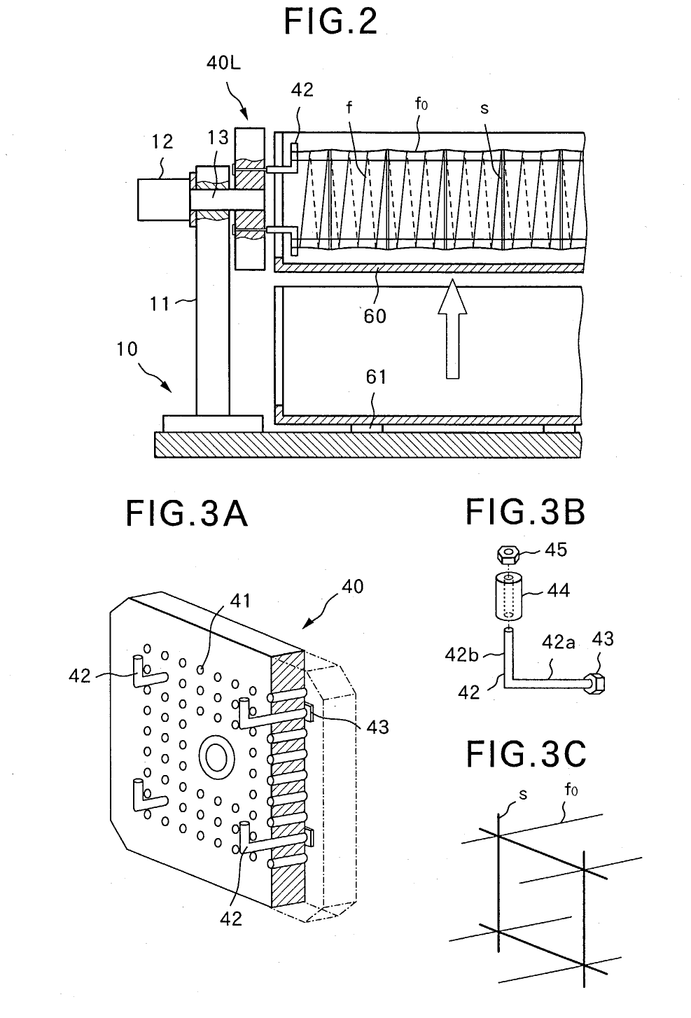

A motor 12 (shown in FIG. 2) is fixed to a column 11 standing up from the stand 10. An anchor-installing base 40L is fixed to a top end of a rotary shaft 13 of the motor 12 extending through the column 11. The anchor-installing base 40L is rotated by a motor 12 driven in response to a signal outputted from a control panel 50. Another anchor-installing base 40R is fixed to the other stand 20. The anchor-installing base 40R may be actively rotated by the similar motor, but passive rotation of the base 40R following rotation of the base 40L is also adoptable.

The carrier 30 has a top board 32, on which a reel 33 and a vessel 34 are mounted. Continuous carbon fibers f are drawn out of the reel 34 and fed through a guide tube 35 toward the base 40L. The vessel 34 receives adhesive b such as an epoxy resin therein. The adhesive b is fed from the vessel 34 through another guide tube 36 and applied to a L-shaped anchor 42 of the base 40L as well as a crossing point of long carbon fibers f₀ with the continuous carbon fibers f.

Travel of the carrier 30 on the rails 31 is controlled by a signal outputted from the control panel 50.

A plurality of holes 41 are formed with a check pattern in the bases 40L, 40R. For instance, four holes 41 at proper positions are selected in correspondence to size and shape of an objective reinforced concrete member, as shown in FIG. 3A. The L-shaped anchor 42, which has an uprising part 42b for tying and fixing the continuous carbon fiber f, is inserted into each of the selected holes 41, and fixed to each of the bases 40L, 40R by screwing a nut 43 to a leg 42a of the anchor 42 projecting from the hole 41 at the opposite side.

A synthetic collar 44 is detachably put on the uprising part 42b of the anchor 42 by screwing a nut 45 to the part 42b, as shown in FIG. 3B. One or some collars 44 may be put on the part 42. Of course, the continuous carbon fibers f may be directly tied to the uprising part 42b of the anchor 42 without attachment of the collar(s) 44. Other type of anchors are also useful instead of the L-shaped anchor 42, as far as the continuous carbon fibers f can be tied thereto.

After the L-shaped anchors 42 are attached to the bases 40L, 40R at proper positions, the continuous carbon fibers f are drawn out of the reel 33. A top of each continuous carbon fiber f is tied to one anchor 42 (FIG. 1(a) shows the situation that the long carbon fiber f₀ is tied to the anchor 42 at the base 40L), and bonded to the anchor 42 with the adhesive b supplied from the vessel 34. Thereafter, the continuous carbon fibers f is continuously drawn out from the reel 33, and the carrier 30 simultaneously travels on the rails 31 rightwards in FIG. 1A. When the carrier 30 arrives at the other base 40R, the continuous carbon fiber f is tied and bonded to a second anchor 42 of the base 40R at a position corresponding to the former anchor 42 of the base 40L. A predetermined number of the long carbon fibers f₀ are stretched between the left base 40L and the right base 40R, in this way. FIG. 1 shows four long carbon fibers f₀ stretched between the bases 40L, 40R.

The carrier 30 then travels leftwards. The continuous carbon fiber f is continuously drawn again out of the reel 23 and wound around the stretched long carbon fibers f₀ with a right or inclined angle in the manner such that the long carbon fibers f₀ are surrounded with the continuous carbon fibers f During drawing out the continuous fibers f, the anchor-installing bases 40L, 40R are rotated, and the carrier 30 simultaneously travels rightwards.

The continuous carbon fibers f are helically wound around the long carbon fiber f₀ due to combination of rotation of the bases 40L, 40R with unidirectional travel of the carrier 30. A spiral spacing of the continuous carbon fibers f is adjusted by controlling a rotation number of the bases 40L, 40R and a travelling speed of the carrier 30 in response to a signal outputted from the control panel 50. The continuous carbon fibers f are optionally bonded to the long carbon fibers f₀ at the crossing points by the adhesive b supplied from the vessel 34. The continuous carbon fibers f are not necessarily bonded to the long carbon fibers f₀ at every crossing point, but the crossing points for bonding are properly determined accounting size and strength of the reinforcing element. Of course, the continuous carbon fibers f may be naturally stiffened with the adhesive b at a length part crossing the long carbon fiber f₀ with a right angle.

The reinforcing element with predetermined structure is fabricated by winding and bonding the continuous carbon fibers f to the long carbon fibers f₀ as above-mentioned. The reinforcing element is embedded as such in concrete, or folded to compact size suitable for transportation to a work site. The folded reinforcing element is re-expanded to its original shape by stretching the long carbon fibers f₀ on a work site. A tension is applied to the reinforcing element by movement of the stand 20 apart from the stand 10, or by directly stretching the long carbon fibers f₀ with a jack or else.

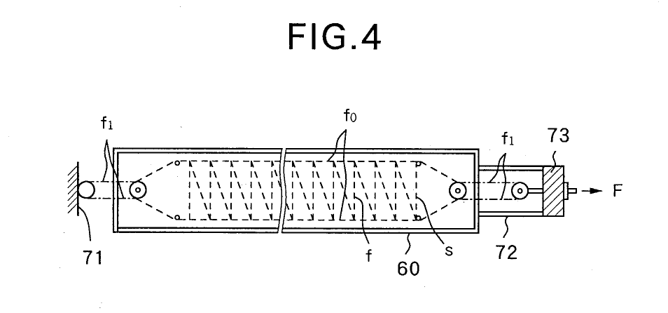

A tension-applying mechanism shown in FIG. 4 is used for embedding the reinforcing element in concrete cast in the molding box 60 on a different work site, after the reinforcing element is fabricated by the steps explained with FIG. 1. In this case, one end of the long carbon fiber f₀ is fixed to a stationary support 71 with a steel wire f₁ or the like, as shown in FIG. 4. An opposite end of the steel wire f₁ is tied to a center hole jack 73, which is provided at a support column 72 in a molding box 60 or on the ground. A predetermined tension is applied to the long carbon fiber f₀ by pulling the reinforcing element with a force F.

In the case where the reinforcing element is embedded in concrete for production of a pre-cast member on the same work site, a molding box 60 (shown in FIG. 2) is raised upwards with a lift 61, from a lower position between the stands 10, 20 to a higher position for receiving the fibers f₀, f therein. The molding box 60 is held at the higher position for casting concrete. Vertical movement of the molding box 60 is allowed by provision of long and narrow notches with width enough for passage of the L-shaped anchors 42 at both sides of the molding box 60 along an axial direction of a reinforced concrete member. The notches are sealed with gummed cloth tape or the like to inhibit leakage of concrete during casting concrete in the molding box 60.

Fresh concrete is supplied from a tank 62 to the molding box 60, which receives the reinforcing element composed of the fibers f₀, f therein. The reinforcing element is embedded in and integrated with cured concrete. An objective carbon fiber-reinforced concrete member is fabricated in this way.

Dislocation of the fibers f₀, f may occur due to a pressure of concrete flow during casting. Such dislocation is suppressed by location of spacers s (shown in FIGS. 2 and 3C) in proper intervals at a space inside the long carbon fibers f₀ stretched between the anchor-installing bases 40L and 40R. Either a rod or a plate may be used as the spacer s. The spacers s are embedded together with the reinforcing element in the concrete member.

Concrete is cast in the molding box 60 under the condition that a tension is applied to the long carbon fibers f₀. In this sense, a pre-stress is easily applied to the reinforcing element along an axial direction of the concrete member. The reinforcing element exhibits a hoop effect due to the continuous carbon fibers f helically wound around the long carbon fibers f₀. Consequently, the reinforced concrete member fabricated in this way is very strong with high reliability on quality and performance. The reinforcing element, which is prepared by winding the continuous carbon fibers f around the long carbon fibers f₀, can be folded to compact size suitable for transportation to a work site, so it is easy to fabricate a reinforced concrete member with size well-fitting to a demand on a work site. Furthermore, use of carbon fibers as a reinforcing element does not need such gas pressure welding as in case of conventional concrete members reinforced with steel rods or FRP, but facilitate scrap processing and recycling.

### INDUSTRIAL APPLICABILITY OF THE INVENTION

According to the present invention as mentioned above, a reinforcing element with size well-fitting to a practical demand on a work site is prepared by winding continuous carbon fibers around long carbon fibers, which are stretched along an axial direction of a concrete member, with a right or inclined angle. The reinforcing element can be folded to compact size suitable for transportation to a work site without any affection of traffic regulations. Consequently, a reinforced concrete member is fabricated with ease by embedding the reinforcing element in concrete at a factory or on a work site, and field-work is simplified and automated to a great extent. Since the stretched reinforcing element is embedded in concrete, a fabricated concrete member is bestowed with a sufficient pre-stress and a hoop effect. Furthermore, scrap processing and recycling are easy due to use of carbon fibers as a reinforcing element.

1. A method of manufacturing a carbon fiber-reinforced concrete member, which comprises the steps of:
detachably attaching a plurality of anchors to a couple of anchor-installing bases each apart from the other;
tying a plurality of long carbon fibers in stretched state to said anchors at both ends;
winding continuous carbon fibers around said stretched long carbon fibers with a right or inclined angle to fabricate a reinforcing element;
setting said reinforcing element in a molding box; and
casting concrete in said molding box under the condition that a tension is applied through said anchor to said reinforcing element.

2. The method defined in claim 1, wherein the continuous carbon fibers are bonded to the long carbon fibers at crossing points.

3. The method defined in claim 1, wherein spacers are located at a space inside the long carbon fibers stretched between the anchor-installing bases.

4. An apparatus for manufacturing a carbon fiber-reinforced concrete member, which comprises:
a couple of rotatable anchor-installing bases, to which a plurality of anchors are detachably attached for tying both ends of long carbon fibers extending along an axial direction of a concrete member; and
a carrier, which travels between said anchor-installing bases simultaneously with rotation of said anchor-installing bases, having a reel and an adhesive vessel mounted thereon;
whereby continuous carbon fibers are drawn out of said reel and tied to said anchors so as to stretch long carbon fibers between said anchor-installing bases, and continuous carbon fibers drawn out of said reel are wound around said stretched long carbon fibers with a right or inclined angle by combination of rotation of said anchor-installing base with unidirectional travel of said carrier.

5. The apparatus defined in claim 4, wherein a molding box, in which a reinforcing element composed of the long carbon fibers and the continuous carbon fibers are received and fresh concrete is cast, is provided movably along a vertical direction between the anchor-installing bases.
